(19) United States
(12) Patent Application Publication
(10) Pub. No.: US 2016/0342873 A1
(43) Pub. Date: Nov. 24, 2016

(54) PALETTE-BASED OPTICAL RECOGNITION CODE GENERATORS AND DECODERS

(71) Applicant: Winkk, Inc., Atherton, CA (US)

(72) Inventors: Dmitry FELD, Oakland, CA (US); Mikhail PETRUSHAN, Rostov-on-Don (RU)

(21) Appl. No.: 15/147,786

(22) Filed: May 5, 2016

Related U.S. Application Data
(60) Provisional application No. 62/157,263, filed on May 5, 2015.
(60) Provisional application No. 62/248,605, filed on Oct. 30, 2015.

(51) Int. Cl. G06K 19/06; G06K 7/10

(52) U.S. Cl. CPC G06K 19/0614; G06K 19/06037; G06K 7/10722

(57) ABSTRACT

An Optical Recognition (OR) code mark is provided. In one example, an OR code includes a segmented portion and a registration mark (e.g., in the form of an iris or pupil) positioned relative to the segmented portion. The OR code mark, e.g., as part of the segmented portion, includes a calibration region having 3 or more different colors, where each color is associated with a number (e.g., “0”, “1”, “2”, . . . “n”, and so on). The segmented portion of the mark is further colored (with the at least 3 different colors of the calibration region) to encode the segments. Accordingly, the OR code can be detected using the registration mark and calibration region to identify and assign values to the segmented regions and decode the mark.

### RELATED APPLICATIONS

The present application is related to and claims benefit of U.S. provisional patent application Ser. No. 62/157,263, titled “PALETTE-BASED OPTICAL RECOGNITION CODE GENERATORS AND DECODERS”, filed on May 5, 2015, and U.S. provisional patent application Ser. No. 62/248,605, titled “PALETTE-BASED OPTICAL RECOGNITION CODE GENERATORS AND DECODERS”, filed on Oct. 30, 2015, and incorporates the contents of both in their entireties by reference for all purposes.

### BACKGROUND

Quick Response (QR) codes are well-known matrix or two-dimensional barcodes used in various applications from product tracking to marketing. QR codes typically include an arrangement of black squares or dots arranged in a grid, and which can be read or imaged by a device and processed to extract data.

Known QR code technology has various technical problems including distortion and size (e.g., small images are unrecognizable). QR codes (and two-dimensional bar codes in general) generally rely on high-contrast shapes and patterns of particular proportions (e.g., black and white bars or squares). This is a reasonable approach that was designed for use with limited imaging devices such as cameras included with mobile phone devices. For example, detection of such codes requires little power for computing and can work on many relatively low cost devices. However, such codes are generally not very tolerant to variations and are not practical for many applications. As such, conventional QR codes are prone to two critical problems: loss of contrast and size tolerance (e.g., smaller sized QR codes may be unrecognizable).

Further, even small distortions or scaling may render QR codes unrecognizable. Further, if a small portion of a QR code is obscured or covered (e.g., with other graphics), the underlying QR code may become unrecognizable. In some cases, if a pattern is printed below a QR code it may cause the QR code to become unrecognizable because contrast of elements can be lost. Additionally, frames, borders, or other patterns around QR codes may render them unrecognizable.

Accordingly, improved optical recognition codes are desired, e.g., optical recognitions codes that are more tolerant to loss of contrast and the detection of smaller sized codes.

### BRIEF SUMMARY

According to one aspect and example of the present invention, an Optical Recognition (OR) code mark is provided. In one example, an OR code includes a segmented portion and a registration mark (e.g., in the form of an iris or pupil) positioned relative to the segmented portion. The OR code mark, e.g., as part of the segmented portion, includes a calibration region having 3 or more different colors, where each color is associated with a number (e.g., “0”, “1”, “2”, . . . “n”, and so on). The segmented portion of the mark is further colored (with the at least 3 different colors of the calibration region) to encode the segments. Accordingly, the OR code can be detected using the registration mark and calibration region to identify and assign values to the segmented regions and decode the mark.

According to another aspect and example of the present invention and exemplary system and process are provided for decoding an OR code including a segmented portion and registration mark.

Additionally, systems, electronic devices, graphical user interfaces, and non-transitory computer readable storage medium (the storage medium including programs and instructions for carrying out one or more processes described) for generating and/or decoding optical recognition codes are described.

### BRIEF DESCRIPTION OF THE DRAWINGS

The present application can be best understood by reference to the following description taken in conjunction with the accompanying drawing figures, in which like parts may be referred to by like numerals.

FIGS. 1A-1C illustrate exemplary OR codes according to various examples provided herein.

FIGS. 2A-2C illustrate exemplary calibration arcs mapped to an encoding palette according to various examples.

FIG. 3 illustrates an exemplary image of an OR code using various masks according to one example.

FIGS. 4A-4C illustrates exemplary candidates of an imaged OR code according to various examples.

FIGS. 5A-5C illustrates exemplary processes for determining a recognized OR code orientation and segment arc boundaries for various examples provided herein.

FIGS. 6A-6C illustrates exemplary sequences of calibration segmented arcs and coding arcs of an OR code in various examples.

FIG. 7 illustrates exemplary frames of a console decoding OR codes.

FIG. 8 illustrates an exemplary process for detecting and recognizing an OR code according to one example.

FIG. 9 illustrates exemplary steps of an affinity-based decoding algorithm according to one example.

FIG. 10 depicts an exemplary computing system 1400 configured to perform any of the described processes, including the generation, reading, and/or decoding of optical recognition codes provided herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

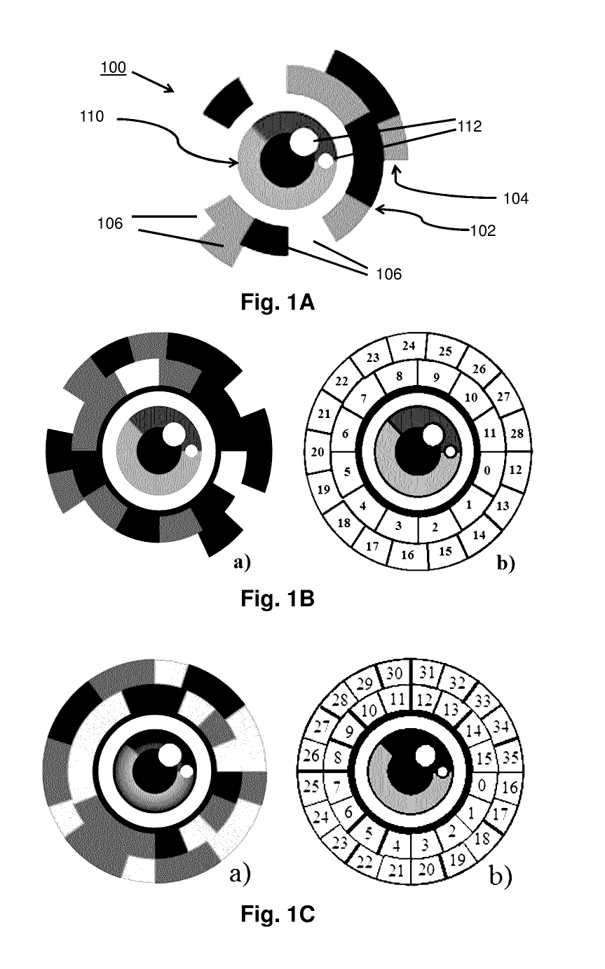

According to one example, an optical recognition (OR) code is provided, the OR code having at least three colors arranged in an arc, e.g., along a portion of a circle, ellipse, or other curved or linear geometry. The OR code further having a calibration region for providing the at least three colors and a registration mark for orientating the OR code upon detection. An exemplary OR code 100 is illustrated in FIG. 1A. In this example OR code 100 includes an inner ring 102 and an outer ring 104, where the inner ring 102 includes eleven colored segments 106 and outer ring 104 includes twelve colored segments 106 (segments 106 are more clearly delineated in FIGS. 1B and 1C discussed below).

FIGS. 1B and 1C illustrate other exemplary OR codes with color segments on the left, and a schematic view of the OR code on the right, showing the number of colored segments in these examples. In particular, the OR code of example FIG. 1B includes 12 colored segments in the inner ring and 17 colored segments in the outer ring, indexed from 0 to 28. Further, the example of FIG. 1C shows a n OR code on the left and scheematic view of the OR code on the right having 16 colored segments in inner ring and 20 colored segments in outer ring indexed from 0 to 35. It will be recognized that other numbres of rings (partial or complete) and segmentations are possible.

Exemplary OR codes described herein may provide improved optical recognition (e.g., more tolerant to loss of contrast and transformations) relative to conventional QR codes or barcodes. In particular, exemplary OR codes provide improved recognition robustness when included or printed on glossy paper or products.

Broadly speaking, and with reference generally to FIGS. 1A-1C, the OR code is based on the generation of a set of arcs within two rings placed around a stylized iris 110 having glints 112 (which together act or are used as a registration mark for the OR code). In this example, arc segments 106 are colored or painted in three different colors (but as will be explained in further detail, more than three colors may also be used). Further, in this example, the iris, pupil, and glints are painted in green, black, and white. These three elements of the OR code may be constant and used for OR code detection and orientation. The OR code can be imaged by a camera included with a mobile device, for example, and processed into a decimal code for use similar to conventional QR codes (for example, the decoded code can be communicated to a remote device or server to retrieve information).

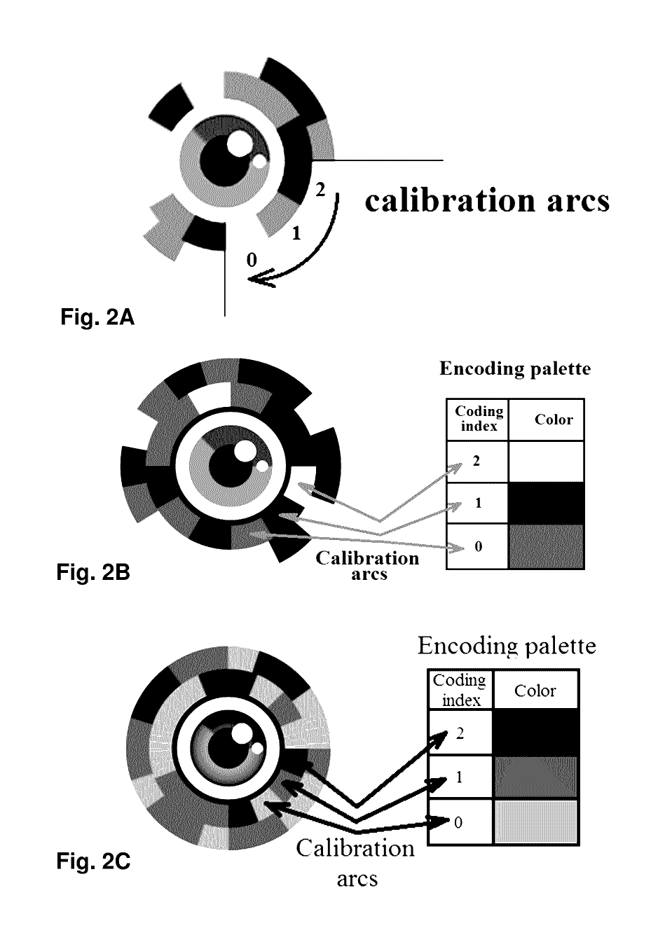

In one example, the first ring (e.g., the inner ring 102, smaller radius) is composed of 16 colored arc segments 106, the second ring is composed of 20 colored arc segments 106. Accordingly, 36 colored arc segments are arranged on the two rings. Three arcs of the inner ring (see FIG. 2A) can be used as calibration elements or a calibration region. These elements set an encoding palette for the OR code. During a recognition or imaging process, the colors of coding arcs are compared with calibration colors. In this example, the colors of the calibration arcs correspond to the numbers “2”, “1”, “0”. In other examples, other regions (e.g., other rings or segments can be used for calibration colors).

FIGS. 2B and 2C illustrate exemplary calibration arcs mapped to an encoding palette generally corresponding to the exemplary OR codes of FIGS. 1B and 1C, respectively. The remaining 33 color segments represent a code in ternary notation. This code number in decimal notation is in the range [0000000000000000-5559060566555523]. Decimal code is composed of two parts. Four leading digits refer to a checksum which is in the range 0000-5558. 12 trailing digits refer to the pure code which is in the range 000000000000-999999999999. Checksum may be calculated, for example, by division of the code in decimal notation by some prime number in the range 0-5558. Decoding the OR code and color segments is described in greater detail below.

Of course many variations to these examples are possible. For example, the center registration mark, shown as an iris/pupil in this example, may include other shapes (e.g., squares, crosses, triangles, and so on), features (e.g., other orientations features/marks), and may further be disposed outside of the rings (e.g., adjacent or surrounding the outer ring). Additionally, the calibration region may be disposed in other regions or positions relative to the segmented arcs (e.g., with the outer ring, as a linear bar adjacent the ring, with the registration mark, and so on).

Further, although this example includes an inner and outer circle, a single circle or more than two circles are possible. Additionally, the segmented arcs may form a spiral structure, elliptical structure, and so on. Further, shapes such as squares, polygons (pentagons, hexagons, octagons, and so on) having segmented or varying color schemes encoded therein are possible and contemplated (where such shapes can be partial as illustrated in the partial outer circle of example 1 or closed as illustrated by the outer circle of example 2). Further various shapes may be combined, e.g., a segmented inner circle with a segmented outer polygon and so on.

The three or more colors for use in the OR code may vary and are generally chosen to aid in detecting and distinguishing the different colors. For example, selecting colors that are different enough to be easily identified when detected/imaged as different colors.

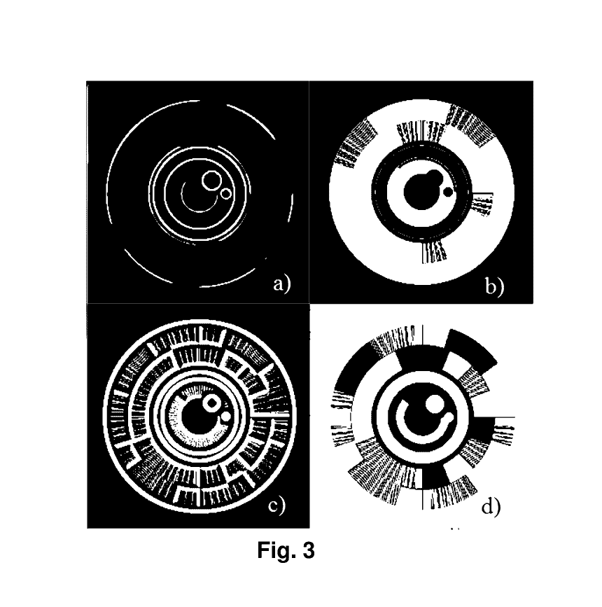

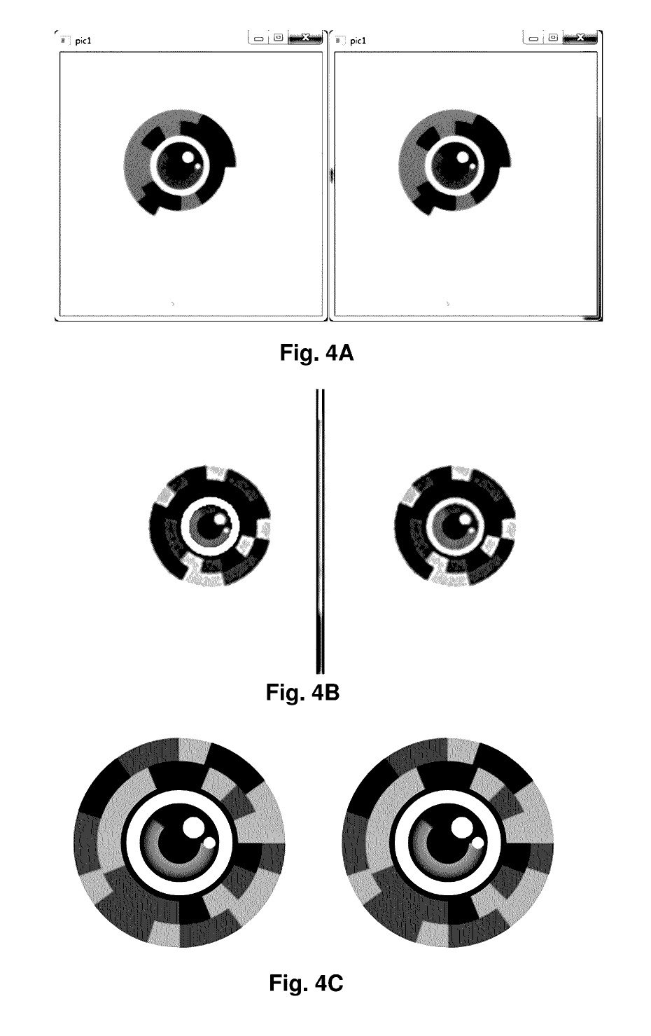

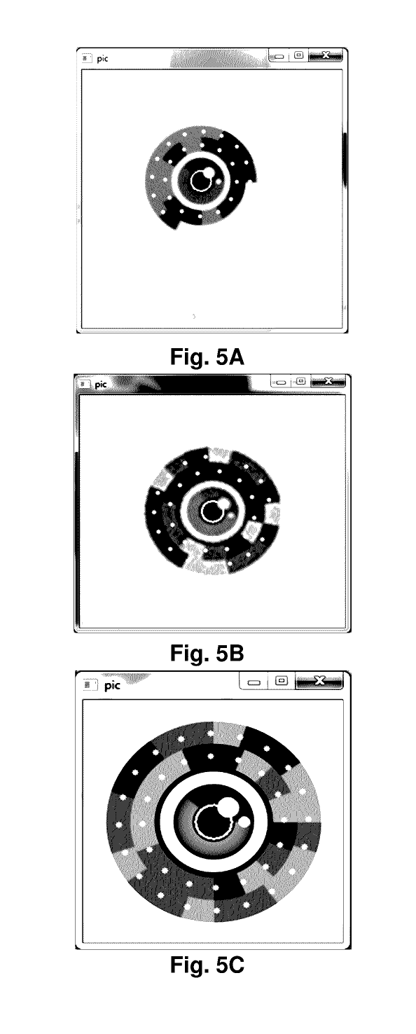

According to another aspect, detection and recognition of an OR code will now be described. Broadly speaking, detection is based on the search of closed elliptical contours in mask images (see FIG. 3, for example, which illustrates exemplary mask images of the OR code shown in FIG. 1C). In this example, four masks are used for contour searching: a variance mask: a) a variance mask that shows distribution of overthreshold variance of intensity over image, b) a green mask that indicates presence of green color, c) an adaptive binarization (ada-bin) mask that shows distribution of high-value intensities over image, and d) a white mask, that indicates presence of white color. Generally, the green mask is more relevant for detection in high lighting conditions, whereas the white mask is more preferable for detection in low lighting conditions. In one example, the variance mask is generated as a map of distribution of overthreshold variance of intensity over image. Variance can be computed for each pixel in 3×3 window. Variance threshold is calculated relatively to maximal value of variance in the image. The adaptive binarization mask can be generated as a map of distribution of high-value intensities over image. The value of each pixel of adaptive binarization mask can be set to 1 if the intensity value of correspondent pixel in an OR code image is larger than intensity value of correspondent pixel in blurred image of OR code. Blurring can be performed by using Gaussian blur kernel (with 9×9 pixels size and sigma=9 in the example below). Variance mask and adaptive binarization masks are more robust for closed elliptic contours search (than green and white masks) in non-uniform lightness conditions and for images of OR codes made with high camera slope and from far distances. Closed elliptic contours are detecting in each mask. An area with minimal contour distortion that satisfies a number of criteria (for example, check the black circle in the center and white ring at the periphery) is selected (see FIG. 4). Rough orientation of the OR code is determined by searching for the registration mark (in this example, searching for and finding the glint in the pupil, i.e., the two white circles on the iris). Orientation of the OR code can then be calculated more precisely by searching for the boundaries between segment arcs in the circles (see FIG. 5).

FIG. 4A illustrates OR code candidates of an imaged OR code. The left image is the correct one, because of low contour distortion and correct positioning of black and white areas of the iris or registration mark relative to contour. FIG. 4B illustrates OR code candidates for a second OR code example. Here again, the left image is the correct one, because of low contour distortion and correct positioning of black and white areas relative to contour. FIG. 4C OR illustrates code candidates for a third OR code example. Again, the left is the correct one, because of correct positioning of black and white areas relative to contour.

Once an OR code is recognized, the process can then orient the OR code and determine segment boundaries. FIG. 5A illustrates an exemplar process for determining a recognized OR code orientation, and in particular, determining segment arc boundaries for the exemplary OR code illustrated in FIG. 1A. As illustrated, the registration mark has been determined and boundary locations of each adjacent segment on the inner and outer rings has been determined (and marked by dots). FIGS. 5B and 5C illustrate similar processes for the exemplary OR codes of FIGS. 1B and 1C.

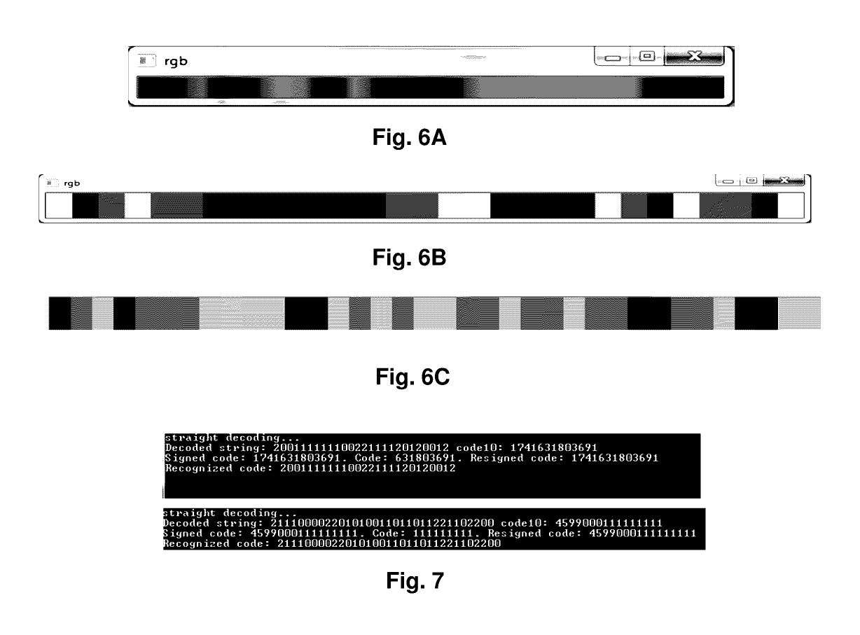

Once segment locations or boundaries are detected, colors of the segmented arcs (see FIG. 6) are compared with the colors of the calibration arc and indexes of most similar calibration arcs are assigned to coding arcs. FIG. 6A illustrates a sequence of calibration segmented arcs (first 3) and coding (last 20) colors of the first OR code example of FIG. 1A; FIG. 6B illustrates a sequence of calibration segmented arcs (first 3) and coding (last 26) colors of the second OR code example of FIG. 1B; and FIG. 6C illustrates a sequence of calibration segmented arcs (first 3) and coding (last 33) colors of the third OR code example of FIG. 1C.

For example, if the first coding arc is the most similar to the first calibration arc, the second most similar to the first, the third most similar to the second, the fourth most similar to the third etc., then the recognized code in ternary notation will correspond to “2210.” This determination is then converted to decimal notation and divided into a pure coding sequence, and a checksum. For example, the checksum of the pure coding sequence is calculated and compared with recognized checksum to identify if the code is recognized correctly. If the same—the code is considered to be recognized correctly (FIG. 7).

FIG. 7 illustrates an exemplary frame of a debugging console. In this example, a hash (i.e., checksum) is computed (first four digits in Resigned code) and recognized (first four digits in Signed code) are the same for the first and second examples. The upper frame demonstrates an example of recognition trial of OR code with 29 colored segments, and the lower frame demonstrates an example of recognition trial of OR code with 36 colored segments.

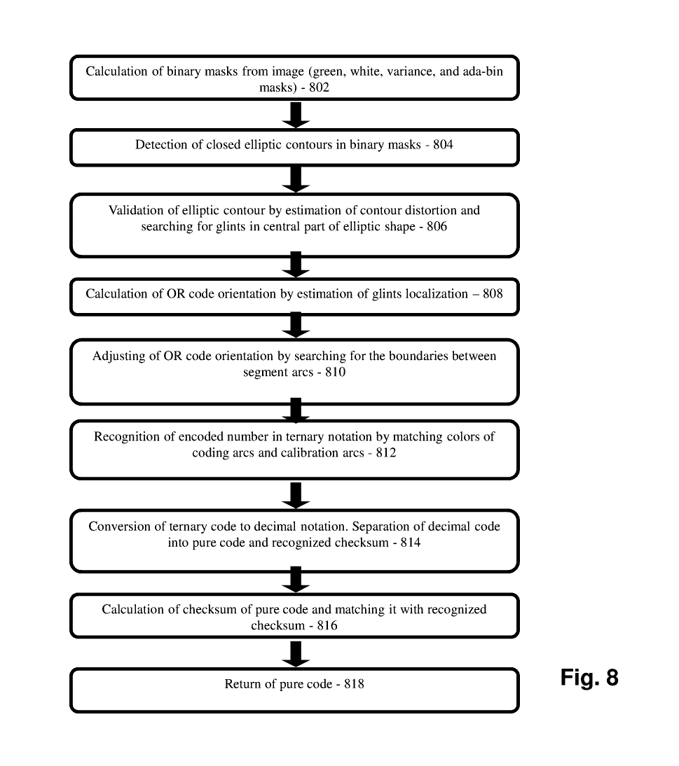

FIG. 8 illustrates an exemplary process for detecting and recognizing an OR code according to one example provided herein. In this particular exemplary process, the process initially calculates the binary masks from a captured image at 802, e.g., the green mask, white mask, variance mask, and ada-bin (adaptive binarization) mask as described herein. The process detects and validates the closed elliptical contours in the binary masks in 804 and 806, where, e.g., the elliptical contours may be validated by estimation of contour distortion and searching for glints in the central part of the elliptical shape as shown in 806. The glints in the central part of the elliptical shape can be used to calculate the orientation of the OR code in 808 by estimating the glints localization. The orientation can be further refined or adjusted by searching and detecting boundaries between segment arcs in the OR code at 810.

At 812, the process may recognize the encoded number in ternary notation by matching colors of coding arcs and calibration arcs, e.g., as described herein. Four different algorithms for color matching can be used for decoding: straight decoding, gradient-based decoding, sat-val normalization, and affinity-based decoding, forming eight different combinations of recognition trials: straight, straight+sat-val, straight+affinity, straight+affinity+sat-val, gradient, gradient+sat-val, gradient+affinity, gradient+affinity+sat-val. Straight decoding procedure performs uniform division of coding circles into separate coding arcs, basing on known total number of segments in the circles. Prime color can be estimated within each coding arc in following manner. Mean values of color components of all pixels in coding arc are computed. Then two steps are iteratively repeated until converged: 1—choosing the half of pixels among all pixels in arc whose colors are most close to computed mean values; recompute mean values of color components of chosen pixels. Converged mean value of color components is the prime color. The prime colors can then be matched with calibration colors by computing Euclidian distance (in RGB space) from analyzing color to each of calibration colors and association current coding segment with calibration region with least distance. Within gradient-based decoding procedure, arc boundaries are adjusting by searching for maximal color gradients between different coding arcs. Sat-val normalization procedure performs converting of colors of coding arcs to new values with standardized values of saturation and value (in HSV color model). Affinity-based decoding is based on clustering of prime colors of coding arcs in color space by growing graphs that are connecting colors of recognizing arcs with colors of calibration arcs.

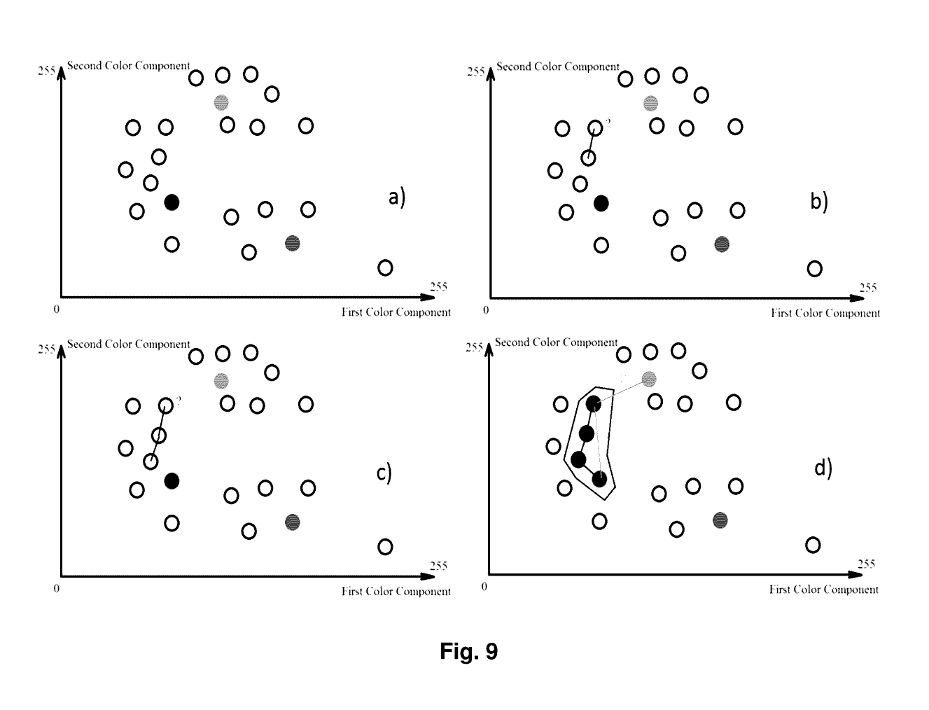

A few steps of an exemplary affinity-based decoding algorithm are schematically shown in FIG. 9. In particular, an affinity-based decoding process in two-component color space is shown: a) distribution of colors of calibration segments (colored circles) and recognizing segments (white circles) in color space, b) first step of graph growing from first analyzing segment marked by “?” symbol by connection it with closest segment, c) second step of graph growing, d) third step of graph growing, connection with calibration segment. Segment marked by “?” symbol is identified as correspondent to darkest calibration color though the distance d2 between analyzing color and darkest calibration color is larger than distance dl between recognizing color and another calibration color.

The conversion of ternary code to decimal notation can then be carried out at 814, and the separation of decimal code into pure code and recognized checksum may be further performed. Further, the process may calculate a checksum of the pure code and match it with recognized checksum to verify recognition at 816. The process may finally return or output the pure code at 818.

The exemplary process is for illustrative purposes only and one of skill will recognize that other imaging processes and functionality may be carried out instead of or in addition to those explicitly described herein. Further, certain processes described may be carried out at least partially in parallel or in series.

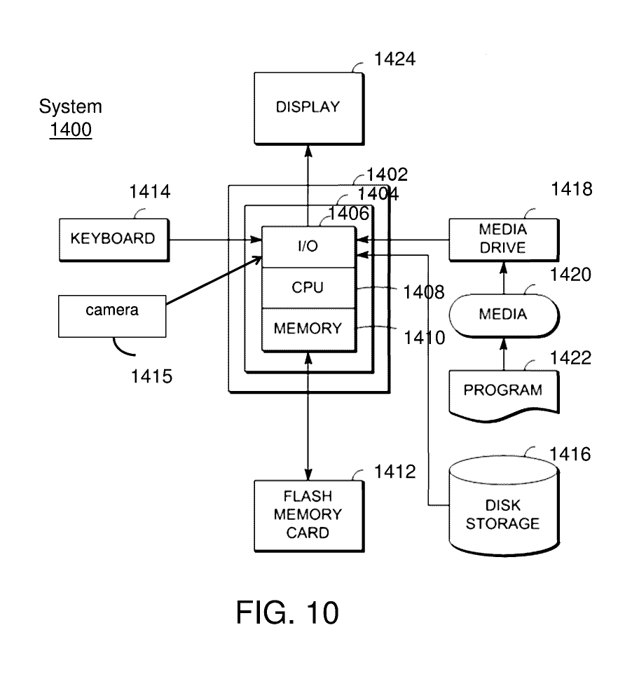

FIG. 10 depicts an exemplary computing system 1400 configured to perform any one of the above-described processes, including the generation, reading, and/or decoding of optical recognition codes. In this context, computing system 1400 may include, for example, a processor, memory, storage, and input/output devices (e.g., monitor/display, camera or imaging device, keyboard, disk drive, Internet connection, etc.). However, computing system 1400 may include circuitry or other specialized hardware for carrying out some or all aspects of the processes. In some operational settings, computing system 1400 may be configured as a system that includes one or more units, each of which is configured to carry out some aspects of the processes either in software, hardware, or some combination thereof.

FIG. 10 depicts computing system 1400 with a number of components that may be used to perform the above-described processes. The main system 1402 includes a motherboard 1404 having an input/output (“I/O”) section 1406, one or more central processing units (“CPU”) 1408, and a memory section 1410, which may have a flash memory card 1412 related to it. The I/O section 1406 is connected to a display 1424, a keyboard 1414, an imaging device or camera 1415 (for imaging OR codes), a disk storage unit 1416, and a media drive unit 1418. The media drive unit 1418 can read/write a computer-readable medium 1420, which can contain programs 1422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed as new and desired to be protected by Letters Patent of the United States is:

1. An optical recognition code mark, comprising:
a registration mark for orienting an optical recognition code;
a calibration region comprising at least 3 different colors;
a segmented portion including segments of at least 3 different colors, wherein the segmented portion is encoded based on the at least 3 different colors.

2. The optical recognition code of claim 1, wherein the segmented portion is encoded in at least a ternary code.

3. The optical recognition code of claim 1, wherein the segmented portion includes segments of at least 4 different colors.

4. The optical recognition code of claim 1, wherein the segmented portion comprises a segmented arc.

5. The optical recognition code of claim 1, wherein the segmented portion comprises a segmented circle.

6. The optical recognition code of claim 1, wherein the segmented portion comprises a segmented polygon.

7. The optical recognition code of claim 1, wherein the segmented portion comprises a segmented line.

8. The optical recognition code of claim 1, wherein the registration mark is centered within the segmented portion.

9. The optical recognition code of claim 1, wherein the registration mark comprises a circle having recognition marks associated therewith.

10. The optical recognition code of claim 1, wherein the calibration region comprises an arc including segments of the at least 3 different colors.

11. A computer-implemented method for reading an optical recognition code mark, comprising:
detecting an optical recognition mark with a camera, the camera operable to distinguish at least 3 different colors;
detecting a registration mark associated with the optical recognition code mark; and
detecting a calibration region associated with the optical recognition code mark, the calibration region comprising at least 3 different colors used to encode the optical recognition code mark.

12. The method of claim 11, wherein the camera is included with a mobile device.

13. The method of claim 12, further comprising decoding the detected colors based on the colors of the calibration region.

14. The method of claim 13, further comprising performing a checksum on the decoded decimal notation to verify the decoding process.

15. A computer-implemented method for encoding an optical recognition code mark, comprising:
receiving a code to encode with an optical recognition code mark;
generating a registration mark for orienting an optical recognition code;
generating a calibration region comprising at least 3 different colors; and
generating a segmented portion including segments of at least 3 different colors, wherein the segmented portion is encoded based on the at least 3 different colors.

16. The computer-implemented method of claim 15, further comprising displaying the optical recognition code.

17. The computer-implemented method of claim 15, further comprising printing the optical recognition code.

18. A system for encoding an optical recognition code mark, comprising:
a processor and a memory, the memory storing instructions for causing the processor to:
generate a registration mark for orienting an optical recognition code;
generate a calibration region comprising at least 3 different colors; and
generate a segmented portion including segments of at least 3 different colors, wherein the segmented portion is encoded based on the at least 3 different colors.

19. The system of claim 18, further comprising causing the processor to display the optical recognition code.

20. The system of claim 18, further comprising causing the processor to print the optical recognition code.
